(19) United States
(12) Patent Application Publication
(10) Pub. No.: US 2005/0073993 A1
(43) Pub. Date: Apr. 7, 2005

(54) Location/stream universe discovery in broadband systems with overlapping streams

(75) Inventor: Douglas S. Makofka, Willow Grove, PA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument Corporation

(21) Appl. No.: 10/934,101

(22) Filed: Sep. 3, 2004

Related U.S. Application Data
(60) Provisional application No. 60/499,834, filed on Sep. 3, 2003.

(51) Int. Cl. H04L 12/56

(52) U.S. Cl. 370/351

(57) ABSTRACT

The structure of the combining/splitting network (10) that forms a node group is analyzed, and that information is then used to craft a set of pilot signals that efficiently and unambiguously determines the client's node group assignment. The present invention can be used in broadband networks, in which clients are organized in groups of nodes, and the grouping cannot be determined a priori. A method (110) for determining a node group to which a client is assigned: uses (111) information included in one or more pilot signals in an MPEG transport stream to determine the node group to which the client is assigned. The method (110) searches (112) for a pilot signal in the MPEG transport stream starting at a predetermined channel location in the MPEG transport stream and moves (113) to a next channel if a pilot signal is not found until a signal is found or all channels have been searched. The method (110) reports (114) an error if no pilot signal is found in any channel. An apparatus for enabling a client to discover a node group assignment includes a pilot signal carousel server (12) continuously outputting a set of pilot signals, one or more edge devices (13a-c) and a combiner/splitter network 14. Each of the edge devices (13a-c) is coupled to the pilot signal carousel server (12) and receives one or more of the one or more pilot signals. The combiner/splitter network (14) is coupled to the edge devices (13a-c) and forms one or more node groups, one for each client, each of which node groups includes one or more pilot signals.

### STATEMENT OF RELATED APPLICATION

This application claims the benefit of priority to U.S. Provisional Patent Application 60/499,834, filed Sep. 3, 2003, entitled “Location/Stream Universe Discovery In Broadband Systems With Overlapping Streams”, the entire specification of which is incorporated by reference herein.

### FIELD OF THE INVENTION

The present invention relates generally to methods and apparatuses for communicating over networks, and more particularly to a method and apparatus for communicating over broadband networks.

### BACKGROUND

In broadband networks typical of digital cable TV systems, many channels are combined together at the head-end. These channels are ‘seen’ at the other end of the cable TV system by the client devices (e.g., set-top boxes). In two-way cable systems, there also exists a return path from the client device(s) to the head-end. This collection of channels ‘seen’ by the client device is a node group.

The Node Group (NG) is the location (or ‘address’) of the client device in the broadband network. The services/programs available to the client device, as well as the path which on-demand video services must take to reach the client device, depend on the NG to which it is connected.

The NG is determined by the combining network usually residing in the cable operator's head-end. Signals carrying video, audio, data, and other content are typically combined and split at the RF level. Broadcast services, for example can be split into many NGs. On-demand video servers may be directed to a single NG.

Historically, broadband cable systems contained only one-way, broadcast video services. For this type of system, the NG configuration is not a critical factor as all NGs contain basically the same set of signals (channels). As more on-demand and data services are added, different NGs are fed by different sources. A client on one NG can only see the on-demand sources associated (combined) in that NG.

Broadcast services share bandwidth between client devices. All clients in a NG tuning to the same broadcast service tune to the same video source. On-demand services typically require a separate video source for each client device. As more simultaneous on-demand services are used, the bandwidth requirements for a given number of client devices increases. This causes the number of client devices attached to a NG to be reduced. For example, a NG with 500 homes attached to it may be split into two NGs with 250 homes attached to it. This causes the number of NGs needed to support a given population of client devices to increase.

For these reasons, controlling the NG structure, and easily determining to which NG a client device is attached becomes more difficult, yet more important to the correct operation of the broadband system.

Several methods exist for determining a client's node group assignment in a network; however, each of these methods is either inefficient or does not work at all in some NG configurations. For example, a brute force technique can be used, in which a client device tunes to all channels and reports back all that can be accessed. Alternatively, an algorithm can be used to find a “well known” channel and report that back. Sometimes, an installer manually enters the node group number into the client device when it is installed. This usually requires a call to the central office to match the street address of the client device to the NG number.

The present invention is therefore directed to the problem of developing a method and apparatus determining a client's node group assignment in an efficient, automatic manner that does not require human intervention for the client device to determine the NG to which it is connected.

### SUMMARY OF THE INVENTION

The present invention solves these and other problems by providing a method for analyzing the structure of the combining/splitting network that forms the node group, and using that information to craft a set of pilot signals that can be used to efficiently and unambiguously determine a client's node group assignment. The pilot signals contain messages that instruct the client device as to the steps needed to determine to which NG it is attached. These steps include finding additional pilot signals, reporting errors, and reporting the proper NG association back to the head-end.

The client device can algorithmically search for any pilot signal. Once a pilot signal is found, it follows the instructions contained in the pilot signal messages.

The present invention can be used in any type of network, in which clients are organized in groups of nodes. An example is digital cable TV broadband networks.

### BRIEF DESCRIPTION OF THE DRAWINGS

FIG. 1 depicts an exemplary embodiment of a subsystem for placing pilot signals on a broadband network according to one aspect of the present invention.

FIG. 2 depicts an exemplary embodiment of node group combinations according to still another aspect of the present invention.

FIG. 3 depicts an exemplary embodiment of a delivery network topology according to yet another aspect of the present invention.

FIG. 4 depicts a flow chart of an exemplary embodiment of a method for searching for pilot signal messages by a client to discover a node group to which a client is assigned according to still another aspect of the present invention.

FIG. 5 depicts an exemplary embodiment of a method for enabling a client to discover a node group to which a client is assigned according to yet another aspect of the present invention.

FIG. 6 depicts yet another exemplary embodiment of a method for enabling a client to discover a node group to which a client device is assigned according to still another aspect of the present invention.

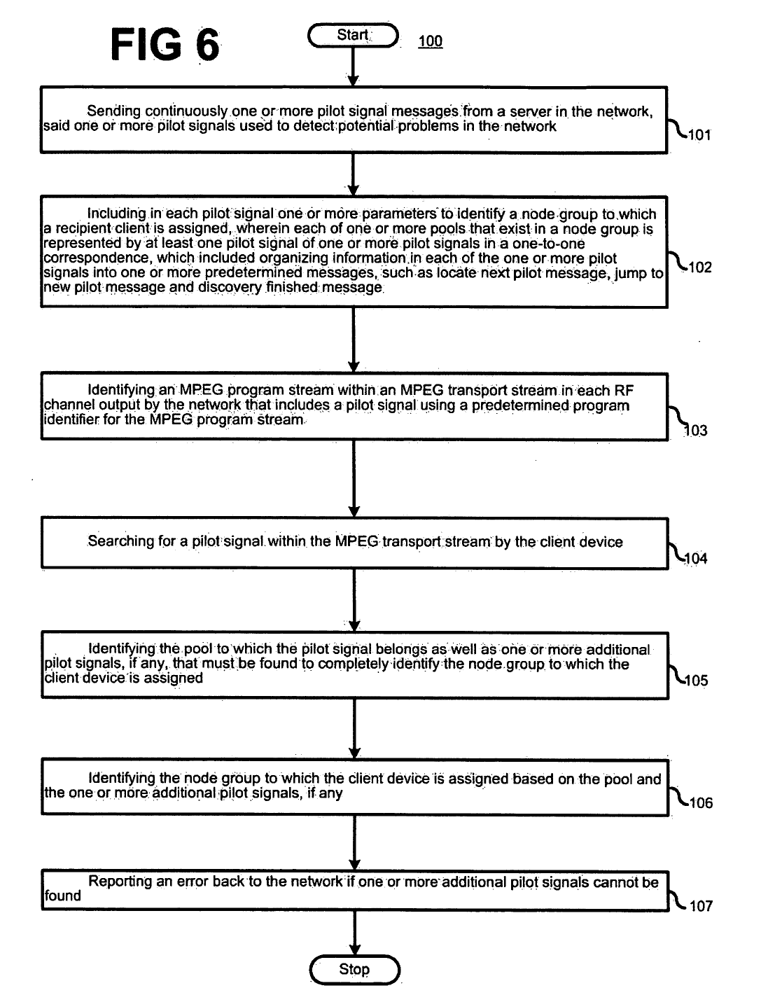

FIG. 7 depicts another exemplary embodiment of a method for discovering a node group by a client according to yet another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention stems from a formal analysis of Node Groups.

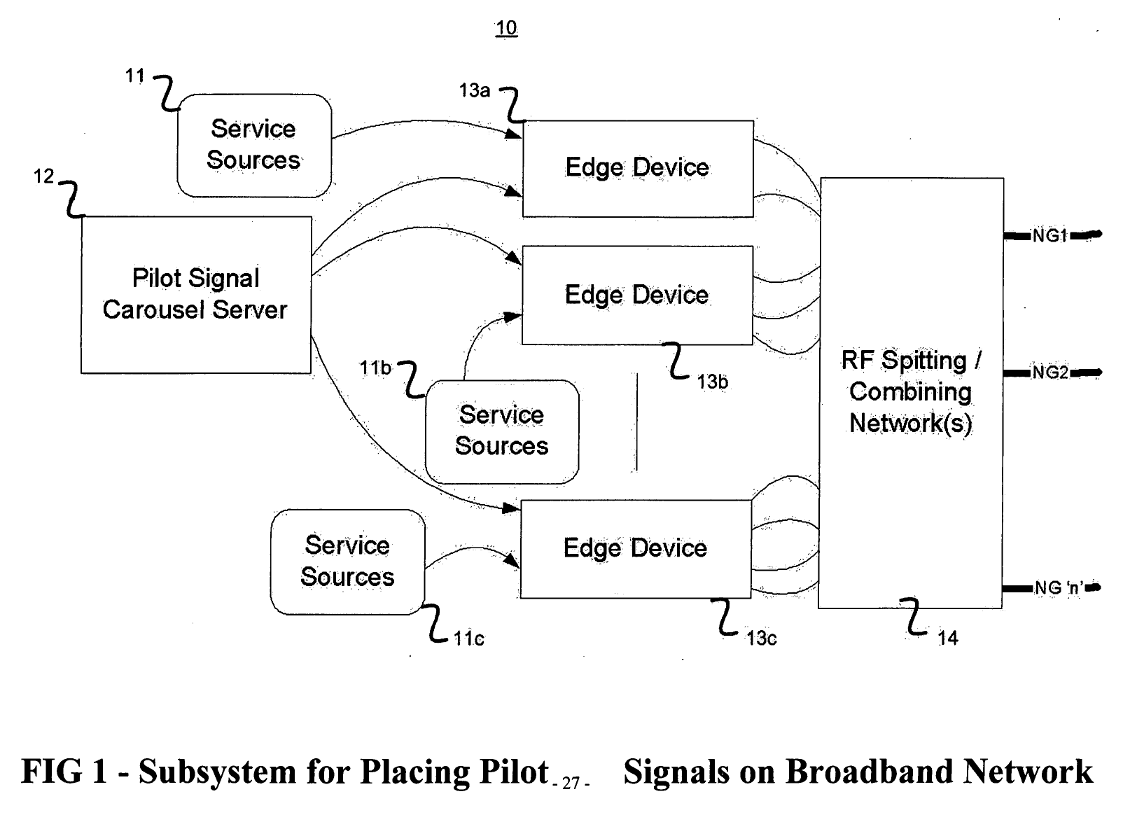

Referring to FIG. 1, the Node Group is defined by the arrangement of combiners and splitters 14 that interconnect the devices 13a-c at the edge of the delivery network 10. A modulator and upconverter are typically placed together in devices known as “edge devices 13a-c.” A Node Group (NG) can roughly be defined as the set of edge device outputs that can reach a set of clients (not shown). Each edge device 13a-c output defines a Transport Stream (TS).

Edge device outputs can be split and combined. Splitting an output allows it to be sent to multiple Node Groups (NG). Combining outputs places those outputs in the same NG. Multiple NG's exist in the broadband network 10 to “multiply” effective bandwidth. Instead of one big pipe seen by every client, multiple “pipes” are created that can contain unique content. Forming the NG topology is an optimization process:
Too few NG's constrain the number of simultaneous session that can be supported (too little available bandwidth)
Too many NG's wastes money as equipment must be duplicated to “fill” each NG.

Typically, edge device outputs are split and combined based on the service, or usages assigned to the output. Here are some considerations used for determining NG contents:
Many edge device outputs are combined together to support OnDemand sessions
Several edge devices just carry broadcast (switched or standard) services.
The outputs of these edge devices are split and sent to all NG's.
Server edge devices are associated with chains used to provide slack resources to handle peak session loads. The outputs of these edge devices are split and sent to multiple NG's.
A client device discovers the unique NG with which it is associated.

The above list is sufficient to motivate the analysis, as we have covered both spitting and combining, and have added different motivations for these operations to allow for the possibility of different management strategies for collections of outputs.

The analysis uses a set-theoretic model of NG's. This model describes the edge device combinatorics that can exist. There are two fundamental parts to the solution:
1. Representing how edge device outputs can be grouped together in NG's;
2. Defining how client devices can discover with what NG they are associated.

Server sources 11a-c provide input or content to edge devices 13a-c, respectively. Pilot signal carousel server 12 outputs a set of pilot signals that are used to detect problems in the network, as well as for use in identifying a node group assignment, in accordance with one aspect of the present invention.

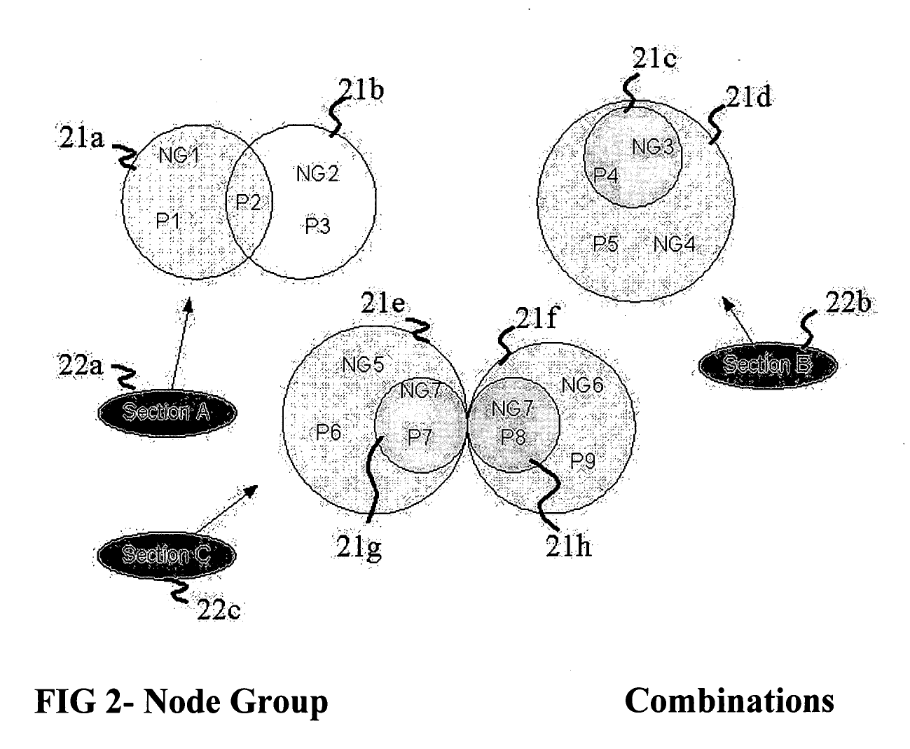

FIG. 2 shows Venn diagrams of some possible ways that NG's can be combined. Venn diagram interpretation is well known in the art. The NGn labels denote the NG's. The Pn labels label distinct regions within the combinations. The Pn labeled regions are called Edge Device Pools, or pools. Any edge device output can occur in at most one pool. If each pool Pn defines a set of edge device outputs, then:

$$\begin{matrix}Pool Disjunction Assertion & Formula 1 \\ P1 ⋂ P2 ⋂ … ⋂ Pn = Ø & \end{matrix}$$

Also, every edge device output is a member of a pool:

$$\begin{matrix}Edge Device \text{/} Pool Association Assertion & Formula 2 \\ ∀ e ∈ outputs , ∃ {P}_{n} \text{:} e ∈ {P}_{n} & \end{matrix}$$

By Formula 1 and 2, every edge device e is a member of one and only one pool Pₙ. There is another important property of pools (that every TS/edge device output in a pool “reaches” the same set of client devices), but that will be deferred until Section 4.1.1.

The Section diagrams in FIG. 2 can be interpreted as follows:
Section A—There are two NG's that share a set of edge device outputs. The edge device outputs could be shared broadcast transports, or shared slack session resources (resources available in multiple NGs to handle peak demand).
Section B—There are two NG's. NG4 sees all the edge device outputs from NG3, but NG3 sees no edge device outputs from NG4. This models (for example) a system that has not been built out for on-demand services (NG3), and one that has (NG4).
Section C—There are three NG's. NG5 and NG6 are disjoint. NG7 is made up from some edge device outputs seen in NG5 and some edge device outputs seen in NG6. This is a contrived example, but is possible. This could be a temporary arrangement to solve some problem—such as preparing to split NG5 and NG6 into a new NG5, NG6, and NG7, where the first step is to create the NG7 from the broadcast services in NG6, and the VOD services from NG7.

Edge device output pools have been defined in terms of disjoint sets of edge device outputs. It is desirable to define NG's in terms of sets of pools. Client devices need to discover their location on the network—their NG association. It is not something that is set a priori (unless some manual process ties a client address to a specific NG at a specific point in time). The definition of the NG in terms of pools of edge device outputs (hence TS's) is important in modeling client/NG discovery.

Each TS (i.e., edge device output) in a pool “reaches” the same set of clients. This is derivable from the fact that each chain, hence each TS is contained in one and only one pool (which is derivable from Formula 1 and 2). This allows the following assertion about the reach relationship:

$$\begin{matrix}Pool \text{/} Client Similarity Assertion & Formula 3 \\ ∀ {e}_{{i}^{′} j} ∈ output , cl ∈ client \text{:} & \\ reaches ( {e}_{i} cl ) ↔ reaches ( {e}_{j} cl ) & \end{matrix}$$

A NG is the largest set of pools that can ‘reach’ an arbitrary client.

$$\begin{matrix}Common Client Pool Assertion & Formula 4 \\ ∀ {p}_{i , j} ∈ pool , ∃ cl ∈ client \text{:} & \\ reach ( {p}_{i} , cl ) ⋀ reach ( {p}_{j} , cl ) ↔ & \\ ∃ g ∈ NG \text{:} {p}_{i} ∈ g ⋀ {p}_{j} ∈ g & \end{matrix}$$

So, reach(NGn, cl) if for every pool such that pool 0 NGn, reach(pool, cl). Or, client is a member of NGn if it can see every pool in NGn. While this definition is good in theory, it is not practical, as the client has no a priori concept of chain pools. The solution is a Pool Pilot Signal, and a partial ordering of pools.

Pool Pilot Signals

A Pool Pilot Signal could be constructed as a small-bandwidth stream that exists in each pool. Some algorithm allows a client to find at least one pilot within the TS's that reach it. This algorithm could be as simple as a low to high searching every channel in the network. Or there could be at a well-known location for the pilot signal in every NG. In any case, the Pool Pilot Signal either identifies the NG directly, or points to another Pilot that needs to be looked for in order to determine the NG, or (in the preferred embodiment), indicates an error condition. There is some minimal collection of Pilots that must be found to determine NG membership of a client. The actual pilot mechanism used is not significant. Any messaging mechanism or other signal understandable by client devices is sufficient.

Pool Partial Orders and Client NG Membership

Consider Section A of FIG. 2. It has overlapping node groups NG1 and NG2, with P1, P2, and P3 as output pools. There is a partial ordering of the pools in Section A as follows:

$$\begin{matrix}Example Pool Ordering & Formula 5 \\ P1 ⊇ P3 ⊇ P2 & \end{matrix}$$

This ordering follows from the splitting relationship on the outputs in the pool (It can be shown from the formulas that every output TS/chain from a given pool has the same splitting network). P1 and P3 are not split. P2 is split once. Therefore, P1 and P3 are ordered higher than P2.

Pool Pilots are streams of data in each pool as follows:
1. A pilot of the highest order indicates a specific NG;
2. A pilot of less than the highest order indicates other pilots for which to look.

For example, the pilot of pool P1 would indicate NG1. The pilot of pool P3 would indicate NG2. The pilot of P2 would indicate to look for pilot P1 or pilot P3. A client could infer its own NG based on this search.

Client NG membership is based on locating the Pool Pilot signals that unambiguously identifies the set of chain pools that “reaches” the client. Using the pool ordering to craft the pilot signal contents, a very small number of searches are needed, and the search can be deterministic—even if some of the signals are temporarily unavailable (Note that if pilots contained complete pool maps, which should be small, the clients could perform error checking. For example in Section A, a client should never be able to see the pilot from P1 and P3. It should always see P2. If P1 should go off-line, the client could know that it doesn't have sufficient information to determine its NG membership.).

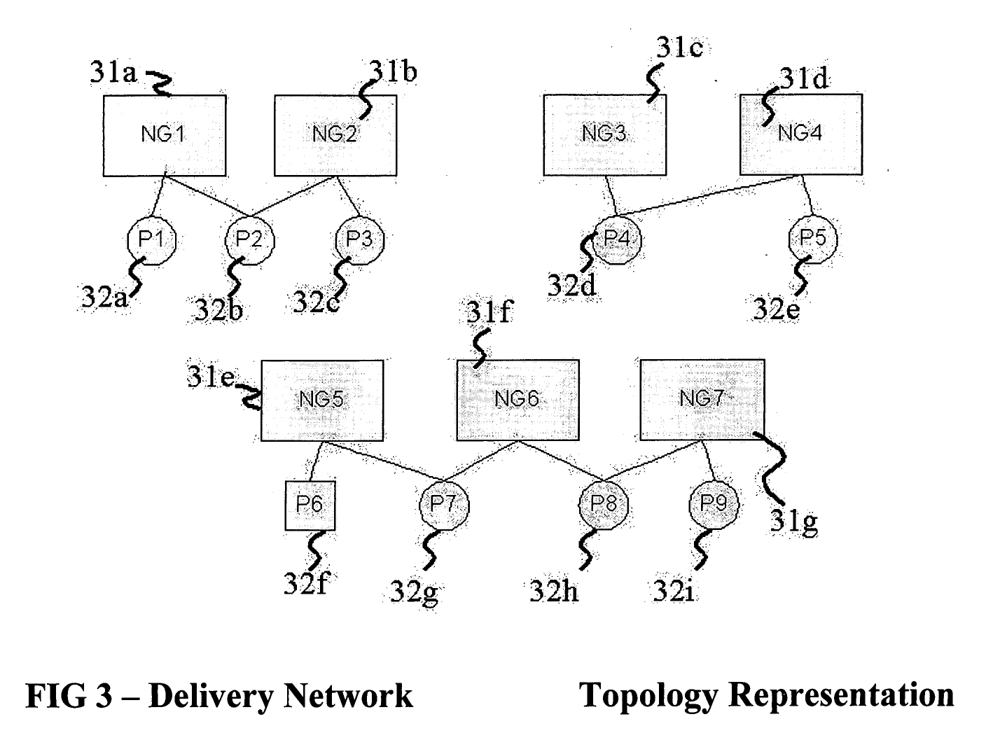

FIG. 3 shows a different representation of NG topology. This representation maps to the NG diagrams given in FIG. 2. It captures the relationships between NG's and pools. An allocation strategy can be developed that takes into account potential resources from the different pools associated with the NG.

Exemplary Embodiment of Method for Identifying Node Group Assignment

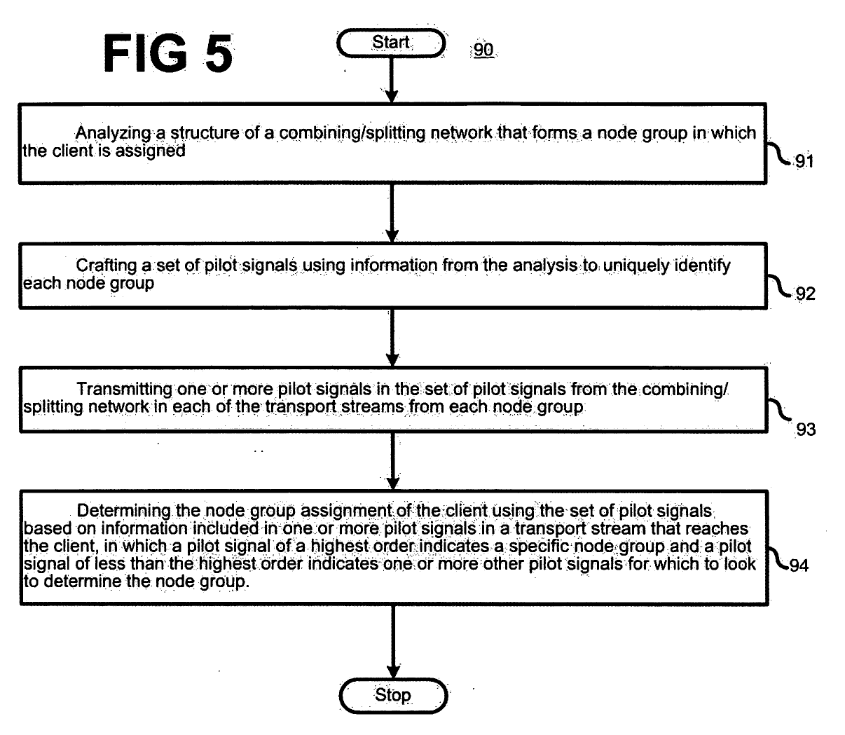

Turning to FIG. 5 shown therein is an exemplary embodiment 90 of a method for enabling a client to identify its node group assignment according to another aspect of the present invention.

In element 91, a structure of the combining/splitting network that forms a node group in which a client is assigned is analyzed. This is performed by the network administrator or a processor within the network under control of the administrator.

In element 92, based on the above analysis a set of pilot signals is crafted to uniquely identify each node group. This is also performed by the network administrator or a processor within the network under control of the administrator.

In element 93, one or more pilot signals from the set of pilot signals are transmitted from the combining/splitting network in each of the transport streams from each node group. Information in each of the one or more pilot signals uniquely identifies the node group in which the one or more pilot signals are included from all other node groups.

In element 94, the client determines the node group assignment based on information included in the one or more pilot signals. The client determines the node group based on information included in one or more pilot signals in a transport stream that reaches the client. A pilot signal of a highest order indicates a specific node group and a pilot signal of less than the highest order indicates one or more other pilot signals for which to look to determine the node group.

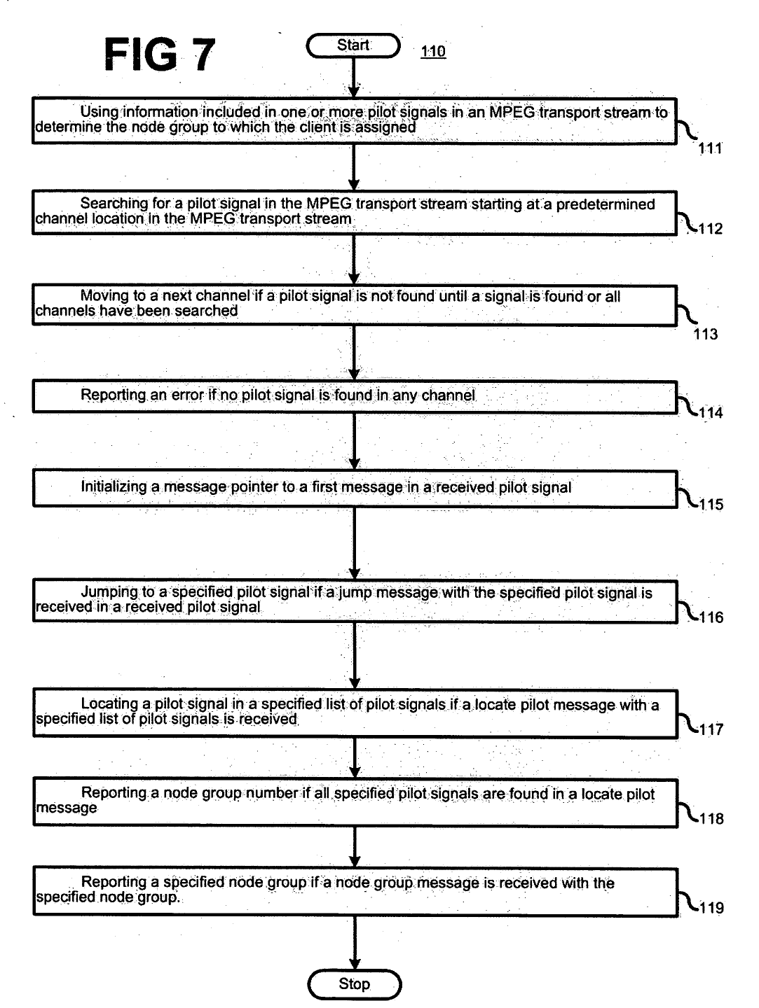

Turning to FIG. 7, shown therein is another exemplary embodiment 110 of a method for identifying a node group to which a client is assigned in a network.

In element 111, information included in one or more pilot signals in an MPEG transport stream is used to determine the node group to which the client is assigned. The client may use this information to ascertain its node group. Alternatively, any processor in receipt of the transport stream can identify the node group that generated the transport stream using this information.

In element 112, a pilot signal is searched for in the MPEG transport stream starting at a predetermined channel location in the MPEG transport stream. This could be some arbitrary channel or the lowest channel or any other predetermined channel.

In element 113, the searching is continued by moving to a next channel if a pilot signal is not found until a signal is found or all channels have been searched.

In element 114, an error is reported if no pilot signal is found in any channel.

In element 115, a message pointer is initialized to a first message in a received pilot signal. The pilot signal may include several messages accompanied by an end of signal message. For example, the client simply waits for the end of signal message and then increments to the next message.

In element 116, if a jump message with the specified pilot signal is received in a received pilot signal, the search continues by jumping to a specified pilot signal.

In element 117, if a locate-pilot message with a specified list of pilot signals is received, the discovery process continues by locating a pilot signal in a specified list of pilot signals.

In element 118, if all specified pilot signals are found in a locate-pilot message, a node group number is reported.

In element 119, if a node group message is received with the specified node group, a specified node group is reported.

Method for Constructing and Delivering Pilot Signals

In broadband cable systems, each RF channel contains MPEG transport streams. These transport streams carry MPEG program streams. Each program stream contains a PID—Program IDentifier. In the preferred embodiment, a well-known PID value identifies an MPEG stream that contains the pilot signal. Other methods are also available—such as using a well-known service name that is mapped to a PID in a manner understood by those versed in the art. A carousel server in the system is used to send the pilot signal messages continuously. FIG. 1 shows an example of a subsystem for sending Pilot signals.

Referring to FIG. 3, each pool, P1-P9 contains one pilot signal. In the preferred method, the pilot signal is constructed to detect potential problems in the cable plant. It is also possible to construct a pilot signal that represents a minimum number of ‘tunes’ to identify the NG to which a client device belongs. The error detection method requires that each of the pools that exists in a NG has a representation in the pilot signal. The pilot signal is constructed such that when the pilot signal is found by a client device, the client device can determine the pool to which the pilot signal belongs, as well as additional pilot signals that must be found. If all the additional pilot signals are found, the client device, via information in the pilot signal, will be told which NG to which it is associated. If the client device cannot find the additional pilot signal(s), it can report that back to the head-end for error detection and correction.

Information in the pilot signals is organized into messages. The format of the messages can be any message format that carries the required information. These methods are well known to those skilled in protocol development. The preferred implementation uses ASCII representation of the messages as given. Recognize that this is but one of many possible message manifestations that could be used to embed the required information (based on our NG analysis) in the pilot signals. The pilot signal contains messages that contain the following commands and information:
LNP[xLst].ng—Locate Next Pilot.

This means that the client must find an additional pilot signal(s) before the NG can be determined. ‘xLst’ is the list of RF channels on which to look for additional pilot signals. If more than one pool is in the list, ‘xLst’ has the format ‘[p1, p2, . . . pn]’, where ‘n’ is the channel of the last signal to be found. ‘ng’ is the Node Group with which to associate the client device if all the signals in the list are found;
JNPx—Jump to New Pilot.

This means that the client is not associated with the NG ‘indicated’ by the PPS containing this message, but should jump to a new pilot and start the discovery process again. ‘x’ is the RF channel on which to look for the next pilot signal. ‘x’ could also be a token value indicating ‘error’, which means that the NG discovery has failed;
NGx—Indicates discovery finished, and client belongs to NG ‘x’.

ENDOFSIGNAL—Indicates the end of the signal. First message in the signal comes after the ENDOFSIGNAL since the signal is sent repeatedly in a cycle. (or carouselled). After the last message (ENDOFSIGNAL) is sent, the carousel server beings again sending the first message.

There are many possible methods for crafting the messages in the Pilot signal. These include:
1). Determining a ‘main’ Pilot signal for each NG; All other Pilot signals have messages that eventually lead a client device to the main Pilot signal. The main Pilot signal contains the set of messages that the client device follows to determine if it's a member of the NG for which the ‘main’ Pilot is associated, and what to do if it is not (e.g., JNP to another signal);
2). Following the ordering relationship given in the NG analysis and generating a set of Pilot signals with messages that flow the client device towards the least general (highest order) Pilot signal, which identifies the NG;
3). Crafting Pilot signals with an ad hoc set of messages such that via testing or other validation methods it can be shown that the right client device/NG association to be discovered.

As an example, the pilot signals for FIG. 3 are constructed as follows—assuming the channel number carrying the pilot signal is the same as the pool number (not a general requirement, just making the example easier to follow):

NG1 contains pools P1 and P2. P2 is shared with NG2, so the pilot signal in P1 is the high-order pilot signal for NG1. The pilot signal for P1 contains the following message sequence:
LNP[2]0.1, JNP[ERR], ENDOFSIGNAL
   Notice that the LNP[2]0.1 message is just for error checking. It's there to be sure the client device can see each of the pools in the NG.

The pilot signal for P2 is of lower order than P1 or P3, so it points to the higher-order signals, and indicates an error to be reported if either higher-order signal cannot be found. The pilot signal for P2 contains:
JNP[1], JNP[3], JNP[ERR], ENDOFSIGNAL

The pilot signal for P3, like that of P1 is a high-order signal for NG2, so it is formed similarly to P1. The pilot signal for P3 contains:
LNP[2]0.2, JNP[ERR], ENDOFSIGNAL

NG3 and NG4 share the P4 pool. The pilot signal for P5 is a high-order signal for NG4. Therefore, the pilot signal for P4 must test for P5. The Pilot signal for P5 contains an error check for P4. The pilot signal for P4 contains:
LNP[5]0.4, NG3, ENDOFSIGNAL

The pilot signal for P5 contains:
LNP[4]0.4, JNP[ERR], ENDOFSIGNAL

NG5, NG6, and NG7 share pools. P6 is a high-order signal for NG5. P9 is a high-order signal for NG7 NG6 contains two shared pools. The messages in the signals follow from the analsysis. The pilot signal for P6 contains:
LNP[7]0.5, JNP[ERR], ENDOFSIGNAL

The pilot signal for P7 contains:
JNP[6], LNP[8]0.6, JNP[ERR], ENDOFSIGNAL

The pilot signal for P8 contains:
LNP[7]0.6, JNP[9], JNP[ERR], ENDOFSIGNAL

The pilot signal for P9 contains:
LNP[8]0.7, JNP[ERR], ENDOFSIGNAL

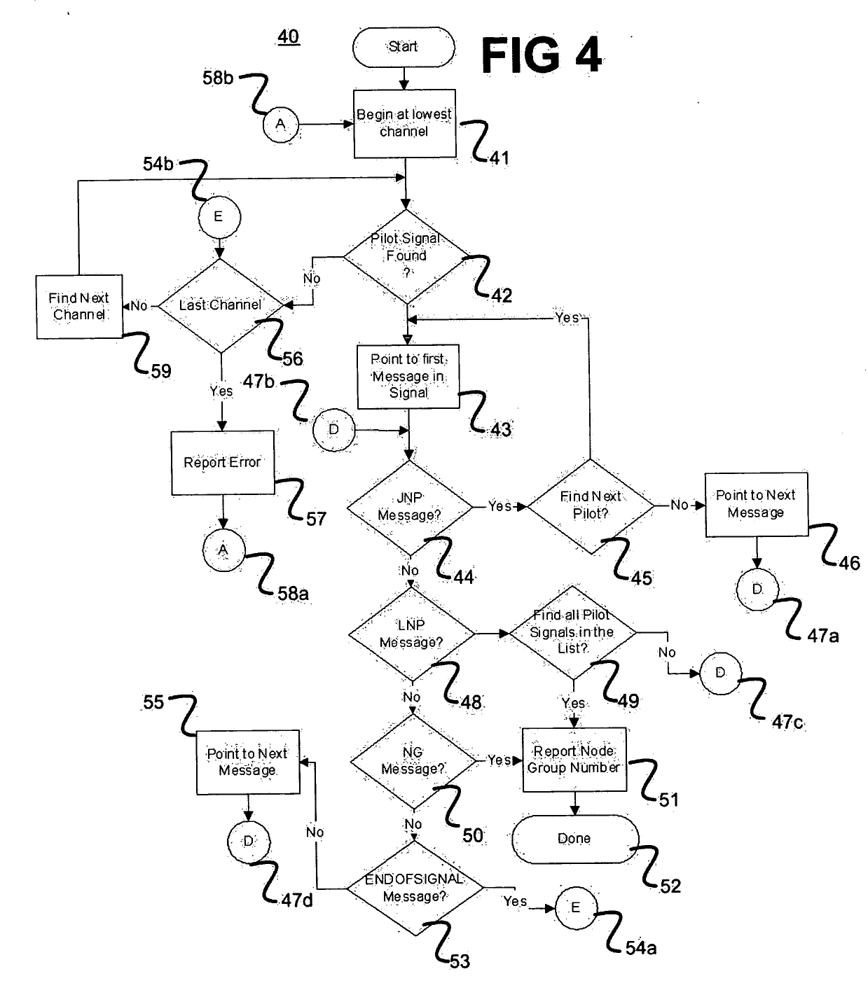

Turning to FIG. 4, shown therein is an exemplary embodiment 40 of a process the client device uses to determine the client device's node group association using information found in one or more pilot signals.

In element 41, the exemplary embodiment 40 begins the discovery process at the lowest channel, and looks for a pilot signal and moves to element 42.

In element 42, if the pilot signal is found, the exemplary embodiment 40 moves to element 43. If the pilot signal is not found, the exemplary embodiment 40 moves to element 56.

In element 43, the exemplary embodiment 40 points to the first message in the pilot signal and moves to element 44.

In element 44, if the message is a jump message, the exemplary embodiment 40 jumps to the specified pilot signal and moves to element 45. If not, the exemplary embodiment moves to element 48.

In element 45, if the next pilot is found, the exemplary embodiment 40 moves to element 43. If not, the exemplary moves to element 46.

In element 46, the exemplary embodiment 40 points to the next message and moves to connector element 47a.

In connector element 47a, the exemplary embodiment 40 moves to connector element 47b.

In connector element 47b, the exemplary embodiment 40 moves to element 44.

In connector element 47c, the exemplary embodiment 40 moves to connector element 47b.

In connector element 47d, the exemplary embodiment 40 moves to connector element 47b.

In element 48, if the message is a locate next pilot message, the exemplary embodiment 40 attempts to find all pilot signals in the specified list and moves to element 49. If not, the exemplary embodiment 40 moves to element 50.

In element 49, if all the pilot signals in the list have been found, the exemplary embodiment 40 moves to element 51. If not, the exemplary embodiment 40 moves to connector element 47c.

In element 50, if the message is a node group message, the exemplary embodiment 40 moves to element 51. If not, the exemplary embodiment 40 moves to element 53.

In element 51, the exemplary embodiment 40 reports the specified node group number and moves to element 52.

In element 52, the exemplary embodiment 40 is finished.

In element 53, if the message is an end of signal message, the exemplary embodiment 40 moves to connector element 54a. If not, the exemplary embodiment moves to element 55.

In connector element 54a, the exemplary embodiment 40 moves to connector element 54b.

In connector element 54b, the exemplary embodiment 40 moves to element 56.

In element 55, the exemplary embodiment 40 points to the next message and moves to connector element 47d.

In element 56, the exemplary embodiment 40 determines whether the current channel is the last channel. If the current channel is the last channel, the exemplary embodiment 40 moves to element 57. If not, the exemplary embodiment 40 moves to element 59.

In element 57, the exemplary embodiment 40 reports an error and moves to connector element 58a.

In connector element 58a, the exemplary embodiment 40 moves to connector element 58b.

In connector element 58b, the exemplary embodiment 40 moves to element 41.

In element 59, the exemplary embodiment 40 finds the next channel and moves to element 42.

Although various embodiments are specifically illustrated and described herein, it will be appreciated that modifications and variations of the invention are covered by the above teachings and are within the purview of the appended claims without departing from the spirit and intended scope of the invention. For example, certain pilot signal message formats are depicted, however, others are possible without departing from the scope of the present invention. Furthermore, these examples should not be interpreted to limit the modifications and variations of the invention covered by the claims but are merely illustrative of possible variations.

1. A method (90) for determining a node group assignment of a client comprising:
analyzing (91) a structure of a combining/splitting network that forms a node group in which the client is assigned;
crafting (92) a set of pilot signals using information from said analyzing; and
determining (94) the node group assignment of the client using the set of pilot signals.

2. The method (90) according to claim 1, further comprising:
transmitting (93) one or more pilot signals from the set of pilot signals from the combining/splitting network in each of the transport streams from each node group, wherein information included in each of the one or more pilot signals uniquely identifies the node group in which the one or more pilot signals are included from all other node groups.

3. The method (90) according to claim 1, wherein said client is organized in one of a plurality of node groups.

4. The method (90) according to claim 1, wherein said combining/splitting network comprises one or more of the following: a cable network, a broadband cable network and a broadband cable television network.

5. The method (90) according to claim 1, wherein said combining/splitting network comprises an on-demand video network.

6. The method (90) according to claim 1, wherein said determining comprises:
determining (94) a node group based on information in one or more pilot signals in a transport stream that reaches the client, wherein a pilot signal of a highest order indicates a specific node group and a pilot signal of less than the highest order indicates one or more other pilot signals for which to look to determine the node group.

7. A method (100) for identifying a node group in network to which a client is assigned comprising:
sending (101) continuously one or more pilot signal messages from a server in the network, said one or more pilot signals used to detect potential problems in the network; and
including (102) in each pilot signal one or more parameters to identify a node group to which a recipient client is assigned, wherein each of one or more pools that exist in a node group is represented by at least one pilot signal of one or more pilot signals in a one-to-one correspondence.

8. The method (100) according to claim 7, further comprising:
identifying (103) an MPEG program stream within an MPEG transport stream in each RF channel output by the network that includes a pilot signal using a predetermined program identifier for said MPEG program stream.

9. The method (100) according to claim 8, further comprising:
searching (104) for one or more pilot signals within the MPEG transport stream by the client.

10. The method (100) according to claim 9, further comprising:
identifying (105) the pool to which the pilot signal belongs as well as one or more additional pilot signals, if any, that must be found to completely identify the node group to which the client device is assigned.

11. The method (100) according to claim 10, further comprising:
identifying (106) the node group to which the client device is assigned based on the pool and the one or more additional pilot signals, if any.

12. The method (100) according to claim 11, further comprising:
reporting (107) an error back to the network if one or more additional pilot signals cannot be found.

13. The method (100) according to claim 7, wherein said including (102) in each pilot signal one or more parameters further comprises organizing information in each of the one or more pilot signals into one or more predetermined messages.

14. The method (100) according to claim 13, wherein the one or more predetermined messages includes:
a locate next pilot message indicating that the client device must find one or more additional pilot signals before the node group can be determined.

15. The method (100) according to claim 13, wherein the one or more predetermined messages includes:
a jump to new pilot message indicating that the client device is not associated with the node group indicated by the pilot signal containing this message, but that the client device should jump to a new pilot signal and start the discovery process again.

16. The method (100) according to claim 13, wherein the one or more predetermined messages includes:
a discovery finished message indicating that discovery is finished, and the client belongs to a specified node group.

17. A method (110) for determining a node group to which a client is assigned comprising:
using (111) information included in one or more pilot signals in an MPEG transport stream to determine the node group to which the client is assigned;
searching (112) for a pilot signal in the MPEG transport stream starting at a predetermined channel location in the MPEG transport stream;
moving (113) to a next channel if a pilot signal is not found until a signal is found or all channels have been searched.

18. The method (110) according to claim 17, further comprising:
reporting (114) an error if no pilot signal is found in any channel.

19. The method according to claim 17, further comprising:
initializing (115) a message pointer to a first message in a received pilot signal;
jumping (116) to a specified pilot signal if a jump message with the specified pilot signal is received in a received pilot signal;
locating (117) a pilot signal in a specified list of pilot signals if a locate pilot message with a specified list of pilot signals is received; and
reporting (118) a node group number if all specified pilot signals are found in a locate pilot message.

20. The method (110) according to claim 17, further comprising:
reporting (119) a specified node group if a node group message is received with the specified node group.

21. An apparatus (10) for enabling a client to discover a node group assignment comprising:
a pilot signal carousel server (12) sending continuously one or more pilot signal messages, wherein said pilot signal carousel (12) includes in each pilot signal one or more parameters to identify a node group to which a recipient client is assigned, wherein each of one or more pools that exist in a node group is represented by at least one pilot signal of one or more pilot signals in a one-to-one correspondence;
one or more edge devices (13a-c) each of which is coupled to the pilot signal carousel server (12) and receives one or more of the one or more pilot signals; and
a combiner/splitter network (14) coupled to the one or more edge devices (13a-c) and forming one or more node groups, one for each client, each of which node groups includes one or more pilot signals.
